(19) United States
(12) Patent Application Publication
(10) Pub. No.: US 2002/0129095 A1
(43) Pub. Date: Sep. 12, 2002

(54) Broadcast communication system with dynamic client-group memberships

(76) Inventor: Atul N. Hatalkar, Chandler, AZ (US)

Correspondence Address: SCOTT C. HARRIS, Fish & Richardson P.C., Suite 500, 4350 La Jolla Village Drive, San Diego, CA, 92122, US

(21) Appl. No.: 09/751,409

(22) Filed: Dec. 29, 2000

(51) Int. Cl. G06F 15/16

(52) U.S. Cl. 709/203

(57) ABSTRACT

In an embodiment, a communication system may include a system host that transmits messages to a number of client devices, which may be dynamically grouped. The system host may link the client identifier of a client in a group to a group identifier and an expiration indicator in a client-group database. The membership information in the database may be updated as groups are added, deleted, or modified, or as client memberships expire. The system host may compile a general membership file from information in the client-group database and transmit it at scheduled intervals. Client devices may update their membership files with the transmitted file and by deleting expired membership records. The system host may transmit messages that include a group identifier in a header. A client device may inspect the header and discard the message if the transmitted group identifier is not found in that client device's internal membership file.

### BACKGROUND

A broadcast communication system may include a host that transmits messages to a number of client devices. An example of a broadcast communication system is a digital cable system that transmits television signals over a cable line from head end to set-top appliances connected to customers' televisions. The head end may transmit general system signals, such as basic cable channels, to all set-top appliances in the system. The head end may also send client-specific signals, including pay-per-view programs or authorizations that are addressed to the set-top appliances of customers that ordered the pay-per-view programs.

At any given time, there may be many messages being transmitted over the system, many of which may not be intended for all of the client devices. At a certain traffic level and demand for particular messages, individually addressing client-specific messages may be cumbersome and time-consuming for the host processor and reduce the available bandwidth in the communication link. It may therefore be desirable to assign clients to groups and address messages to the group rather than the individual clients, and to update the group membership records at the head end and client devices as they are added, modified, or deleted from the system.

### DESCRIPTION OF DRAWINGS

FIG. 1 is a schematic diagram of a communication system capable of dynamically grouping client devices according to an embodiment.

FIG. 2 is a schematic representation of a message format including group addressing according to an embodiment.

FIG. 3 is a flowchart illustrating an operation for updating group memberships according to an embodiment.

FIG. 4 is a flowchart illustrating an operation for receiving group directed messages according to an embodiment.

### DETAILED DESCRIPTION

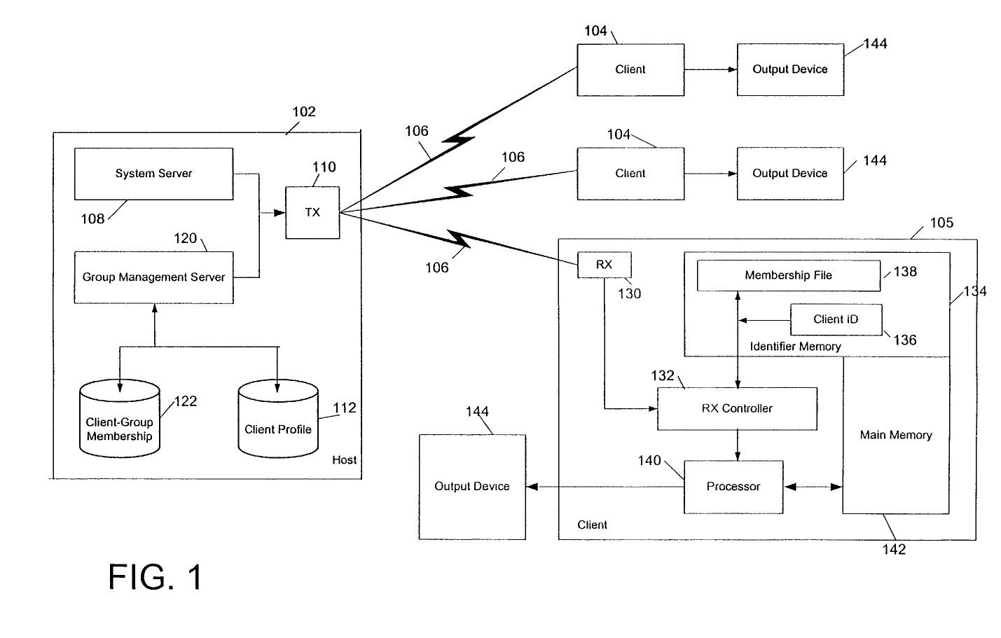

FIG. 1 illustrates a communication system 100 according to an embodiment that may dynamically assign client devices to groups in the system. The system may include a host 102 that may broadcast messages to client devices 104, 105 in the system. The messages may be addressed as general call messages intended for all client devices in the system, client-specific messages intended for particular client devices, and/or group-specific messages intended for client devices belonging to particular groups in the system.

The host 102 may create, modify, and remove groups from the system. A group may include one or more member client devices, and a client device may be a member of none, one, or many groups. The groups may be dynamic, with group memberships changing over time.

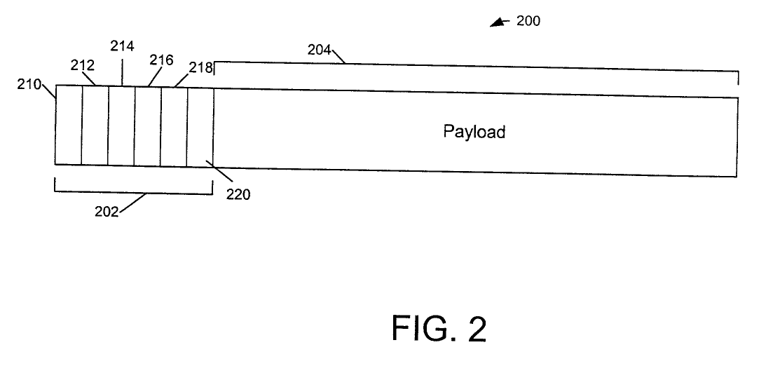

The host 102 may transmit messages to client devices over a communication link 106 .A system server 108 may format messages and transmit them from a transmitter 110. The system server 108 may format the messages into packets 200 that include a header portion 202 and a payload portion 204 as shown in FIG. 2. The header portion 202 may include a client identifier for a client specific message, or a group identifier for a group-specific message. The payload portion 204 may include content such as audio and video signals for television programs and movies, data for electronic program guides and advertisements, software modules for video games, and system management messages. The system management messages may include, for example, authorization information, billing information, and diagnostic and maintenance software modules for servicing the client device 104, 105.

In an embodiment, the header portion 202 may include a number of fields. These fields may include, for example, a protocol version field 210, a target type field 212, a target field 214, a message identifier field 216, a message type field 218, and a payload size field 220.

The value in the protocol version field 210 may identify the version of the protocol used to describe the message.

The value in the target type field 212 may be a Boolean flag which identifies the identifier in the target field as either a client identifier, e.g., value=0, or a group identifier, e.g., value=1. The value in the target field 214 identifies the intended target of the message, which may be a particular client or a group of clients.

The host 102 may transmit messages multiple times, e.g., in a message carousel, to capture client devices that are off or otherwise unavailable at the time of the first transmission. The value in the message identifier field 216 may identify a message as a new message from the host 102, or a repeated message.

The value in the message type field 218 may indicate the type, or purpose, of the message. These types may include, for example, test messages, software download schedule information, and alert messages.

The value in the payload size field 220 may indicate the number of bytes in the payload portion 204. The payload size value may be compared to an actual count of the bytes received in the payload as an error checking measure.

The host 102 may include a client profile database 112. A client device may have an individual client identifier. That client identifier may be associated with profile information for that client device in the client profile database 112. The profile information may include information about a particular client device and customer. This information may include, for example, services and/or products the client device is authorized to receive, orders and subscriptions placed by the customer, geographic and contact information, and demographic information. The demographic information may include, for example, the customer's household income, number and age of children, interests, service and program preferences, number and type of consumer appliances, and historical information, such as payment records, and past subscriptions and orders placed by the customer.

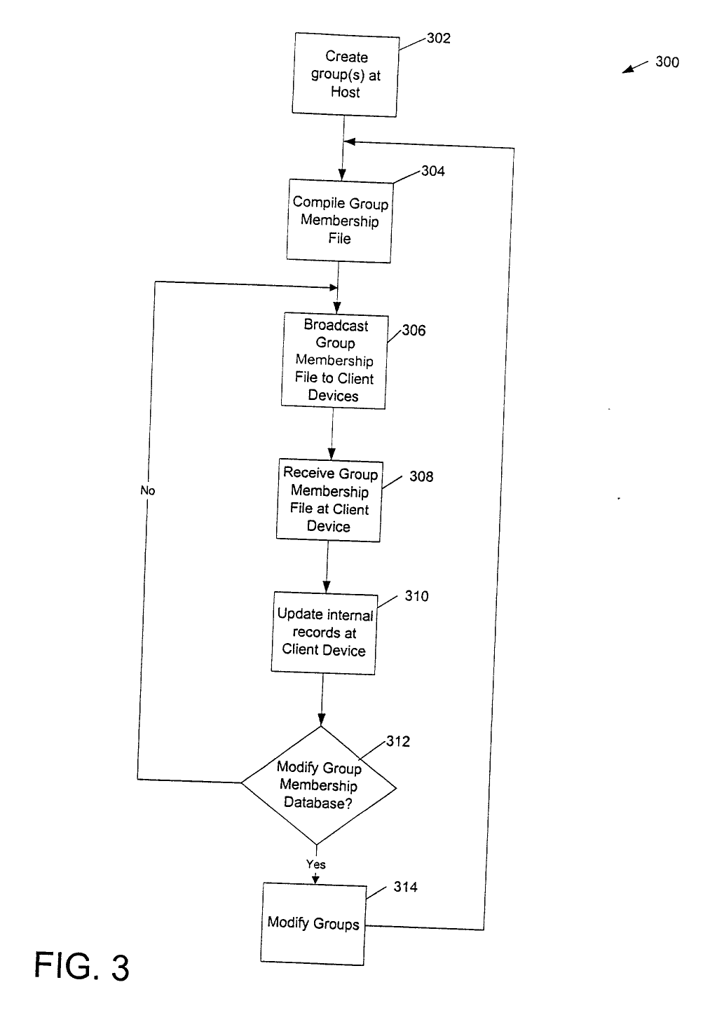

FIG. 3 illustrates an operation 300 for updating dynamic groups in the system according to an embodiment. The flow of the operation 300 is exemplary, and blocks in the flowchart may be skipped or performed in different order according to alternate embodiments.

A group management server 120 may include hardware and software for creating new groups and modifying existing groups based on information in the client profile database 112. The group management server 120 may create a new group from information in the client profile database 112 in block 302. The group may include member clients that share a common criterion. For example, a group may be created for the client devices of customers that have ordered a particular service, for example, a premium channel service in a digital cable system. Another group may be created for the client devices of customers that have ordered a particular product, for example, a video game software module. Another group may be created for customers that belong to certain demographic or geographic groups which may be targeted by certain advertisers. For example, households that report children between the ages of three and nine years may be included in a group that is targeted to receive an electronic catalog of age appropriate toys.

Each group may have a group identifier. The client identifiers of member clients in the group may be linked or otherwise associated with that group identifier in a client-group database 122. As shown in Table 1, a client device may belong to more than one group.

TABLE 1

| Client ID | Group ID |
|---|---|
| 0×00000007 | 0×00001000 |
| 0×00000007 | 0×04000000 |
| 0×00000010 | 0×04000000 |

The group management server 120 may compile a general membership file from the contents of the client-group database 122 in block 304 for transmission to the client devices 104, 105. The general membership file may be a data structure organized as, for example, a file, a database, or a table. The client identifiers of member clients may be mapped to the corresponding group identifier in the general membership file. The compiled general membership file may be transmitted to the client devices in block 306.

The general membership file may be relatively large, and the host may compress the general membership file prior to transmission to conserve the processing resources of the client devices. The general membership file may also be encoded with error checking data.

The client device 105 may include a receiver connected to the communication link 106 for receiving the general membership file and messages from the host 102, a receiver controller 132 to inspect transmissions from the host, and an identifier memory 134. The identifier memory 134 may include a client identifier file 136 to store the individual client identifier of the client device and an internal membership file 138 to store the group identifier(s) of the group(s) in which the client device 105 is currently a member.

Client devices in the system may receive the general membership file in block 308 and use it to update their internal membership files in block 310. When the client device 105 receives the general membership file, the receiver controller 132 may inspect the file for group identifiers the client identifier is associated with and compares those group identifiers to the group identifiers currently stored in the identifier memory 134. Based on this comparison, the receiver controller 132 may store new group identifiers that are associated with the client identifier in the identifier memory 134. The receiver controller may also delete group identifiers that are no longer associated with the client identifier from the identifier memory 134. Thus, the receiver controller 132 may update the internal membership file 134 to agree with the group-client associations contained in the last general membership file transmitted.

The host 102 may transmit the general membership file repeatedly to account for client devices that were not available for reception at the time the general membership file was first transmitted. Such unavailable client devices may include those that were off or out of reception range at the time of the first transmission. Unavailable client devices may also include devices that were busy handling operations having a higher priority than receiving and handling the general membership file. For example, if a customer is using the client device 105, for example, to decode a video or voice signal, the client device 105 may ignore the general membership file and wait for the next transmission.

To reduce the number of unavailable client devices, the host may transmit the general membership file at off-peak times, when many client devices may be idle and better able to utilize their processor resources to handle such system functions. For example, in a digital cable system, the general membership file may be transmitted when most customers are not watching television, for example 3 a.m. In a wireless phone/PDA system, the general membership file may be transmitted every several hours in carousel fashion.

Some client devices may be chronically unavailable. For example, a customer may turn off his or her client device daily after a few hours of use. That client device MAY be removed from a group but may not be available to receive the updated general membership file. This may result in continued access of the service by unauthorized customers, which may cause revenue losses.

To prevent such unauthorized access, a general membership file record may include a group identifier, a client identifier, and an expiration indicator, as shown in Table 2.

TABLE 2

| Client ID | Group ID | Expiration |
|---|---|---|
| 0×00000015 | 0×00001000 | 07 August 2000 |
| 0×00000009 | 0×00005000 | 31 July 2000 |

The expiration indicator may be the date of the next billing cycle for the service or the end of a grace period, such as 15-day or 30-day period. The expiration indicator may be the date of the end of a service or advertisement campaign.

The expiration indicator may be set by the group management server 120 and stored in the client-group database 122 and linked to the group identifier and client identifier in a membership record. The group management server 120 may periodically examine expiration indicators in the database 122 in block 322 and use a clock 180 to identify memberships that have expired. A client device with an expired membership may be removed from a group.

The group management server may update expiration indicators for a client device in response to being notified of a timely payment or renewal of a subscription. The updated expiration indicators may be included in the next transmission of the general membership file, and used to update the membership files of the client devices.

The client device 105 may store an expiration indicator with the corresponding group identifier in the membership file 138. The client device 105 may update the expiration indicator(s) in response to any updates in the last general membership file received.

The client device 105 may include a clock 190. The receiver controller 132 may periodically examine expiration indicators in the membership file 138 in block 320 to identify memberships that have expired. If a membership has expired, the operation may return to block 310 and remove the expired membership record, including the group identifier and expiration indicator, from the membership file 138 in block 310.

Alternatively, the receiver controller 132 may examine the expiration indicator when a group message is received. If the receiver controller 132 finds a group identifier match, it may examine the corresponding expiration indicator in the membership file. If the membership has expired, the receiver controller may discard the message, and update the membership file by deleting the expired membership record.

The group management server 120 may modify the groups in the client-group database 122 over time in block 314 in response to changed circumstances. For example, a new group may be generated for a new service provided by the host 102. An existing group may be deleted when a service campaign ends. New members may be added to a group, for example, new subscribers to a service. Existing members may be removed from a group, for example, subscribers who cancel or are delinquent in payment. As described above, existing members may also be removed if their memberships expire.

When the group management server 120 modifies the groups in the client-group database 122, the operation 300 may return to block 304 and compile a new, updated general membership file. The updated general membership file may be transmitted upon being compiled or at a next scheduled transmission time.

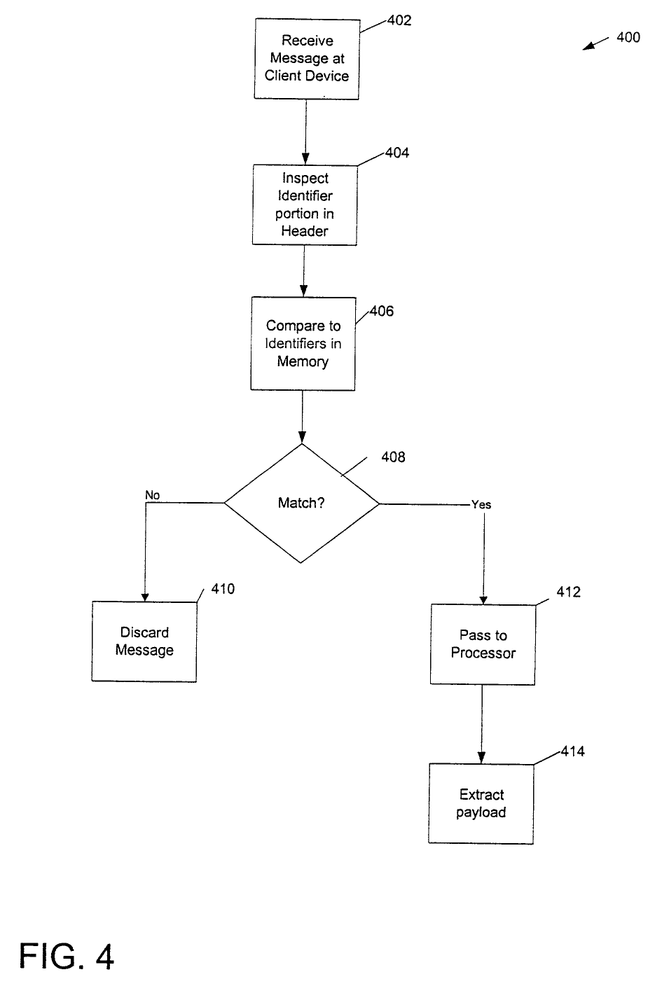

FIG. 4 illustrates an operation 400 for updating dynamic groups in the system according to an embodiment. The flow of the operation 400 is exemplary, and blocks in the flowchart may be skipped or performed in different order according to alternate embodiments.

When the client device 105 receives a message in block 402, the receiver controller 132 may inspect the target type field 212 and target field 214 of the message in block 404 and compare it to the client identifier or the group identifier(s) in the identifier memory in block 406. If the identifier in the header portion does not match any identifier in the client device's identifier memory 134 in state 408, the message may be discarded in block 410. If the identifier in the header portion matches an identifier in the identifier memory 134, the expiration indicator associated with that group identifier (if any) may be examined in block 420. If the membership has expired, the message may be discarded in block 410 and the membership record may be removed from the membership file in block 422. Otherwise, the message may be passed on to a processor 140 in block 412.

The processor 140 may include a microprocessor for executing instructions stored in a memory 142 and processing data. The processor may include a signal processor, such as a digital signal processor (DSP) for processing compressed and encoded digital signals, for example, digital video and audio signals. The processor 140 may extract the contents of the payload portion 204 in block 414 and store the payload in the memory 142 and/or prepare the payload for output to an output device 144. The output device 144 may include, for example, a television, a liquid crystal display (LCD) or cathode ray tube (CRT) display screen, and/or a speaker.

Specific Embodiments

In an embodiment, a digital cable system may include subscription-based groups. When a customer subscribes to a premium channel service, the group management server 120 at the host 102 may update the client-group database 122 to include the customer's client device identifier in the premium channel group. The group management server 120 may set an expiration date, for example, the next billing due date, and include a corresponding expiration indicator in the membership record. At the next broadcast of the general membership file to the client devices 104, 105 in the system, the customer's client device 105 may receive and inspect the general membership file for group identifiers associated with the client device's individual client identifier. When receiver controller 132 finds an association between the client identifier and the premium channel group identifier, the receiver controller 132 may update the identifier memory 134 to include the premium channel group identifier and the associated expiration indicator.

After the update, the receiver controller 132 of the client device 105 inspects the headers of messages transmitted by the host 102. Upon receiving a message that includes premium channel group identifier in the header 202, the receiver controller 132 may examine the expiration indicator to determine if the membership is still valid. If so, the receiver controller passes the message to the processor 140. The processor 140 may extract the payload and output the digital video and audio signals of the premium channels to the customer's television 144.

The customer may cancel the subscription to the premium channel service. If so, the group management server 120 may remove the customer's client device identifier from the premium channel group in the client-group database 122. In the next general membership file transmission, the receiver controller 132 at the client device 105 may inspect the general membership file for an association between the premium channel group identifier in the internal membership file 138 and the client identifier in the client identifier file 136. Finding no association, the receiver controller 132 may update the internal membership file 138 by deleting the premium channel group identifier from the membership file 138.

Alternatively, the customer may allow the subscription to lapse. Once the expiration date indicated in the expiration indicator has passed, the premium channel membership record may deleted upon a routine inspection of the expiration indicators in the membership file 138, or upon an inspection executed in response to receiving a premium channel message.

In another embodiment, the digital cable system may include geographic-based groups. For example, a supermarket may request that the host transmit an electronic advertisement for a sale campaign to system customers in the vicinity of the supermarket. The group management server 120 may query the client profile database 112 for clients in a geographical area, defined, for example, by zip code(s). The group management server 120 may generate a sales campaign group identifier and an expiration indicator set to expire at closing time on the last day of the sales campaign. The group management server 120 may link the sales campaign group identifier and the expiration indicator to the client identifiers returned from the zip code query. An updated general membership file may be transmitted to the client devices in the next transmission cycle, and the member client devices updated to include the sales campaign group identifier and associated expiration indicator in their identifier memories. The system server 108 may format the electronic advertisement into a message(s) with the sales campaign group identifier in the header 202. The message(s) may be transmitted and received by members of the group. The electronic advertisement may be displayed on the customer's television 144 automatically or when selected by the customer.

When the sale campaign ends, the members of the sale campaign group may delete the sale campaign membership record from their membership files upon receiving an updated general membership file or upon a routine inspection of the expiration indicators in their membership files.

In another embodiment, the system may be a wireless network and the client devices may be hand-held PDA units. The PDA units may include Global Positioning System (GPS) modules. The PDAs may periodically transmit their current position to the system host. The system host 102 may update the client profile database 112 with this geographic information. An advertiser, for example a department store having a weekend sale, may use this geographic information to target customers in the vicinity of the department store.

The group management server 120 may generate a weekend sale group identifier and an expiration indicator set to expire near closing time that Sunday. The group management server 120 may link the weekend sale group identifier and the expiration indicator to the client identifiers returned from periodic queries to the client profile with the geographic information. The general membership file may be transmitted periodically over the sale weekend to capture customers traveling in the vicinity of the department store.

When the weekend sale ends, the members of the weekend sale group may delete the weekend sale membership record from their membership files upon receiving an updated general membership file or upon a routine inspection of the expiration indicators in their membership files.

In an embodiment, the communication system 100 with dynamic client grouping may have a head end-to-set-top appliance organization as in many cable, digital cable, and television satellite dish systems. In an alternative embodiment, the communication system 100 may have a central station-to-client organization as in many wireless telephone, wireless internet, wireless personal digital assistant (PDA) systems.

The communication link 106 may be a transmission line such as co-axial cable, fiber optic, plain old telephone system (POTS), or digital subscriber line, or it may be a wireless RF signal transmitted via satellite or base stations to a receiver, such as a dish, or a transceiver, such as those used in wireless hand-held devices. The communication link 106 may include a combination of such communication media.

A number of embodiments of the invention have been described. Nevertheless, it will be understood that various modifications may be made without departing from the spirit and scope of the invention. Accordingly, other embodiments are within the scope of the following claims.

What is claimed is:

1. A method comprising:
storing membership data at a client having a client identification, said membership data including a first group identifier corresponding to a first group and a first expiration indicator;
transmitting a group membership file at a host, said group membership file including a second group identifier associated with a member identifier and a second expiration indicator; and
updating the membership data at the client.

2. The method of claim 1, wherein updating the membership data comprises:
examining the first expiration indicator to determine if membership in the first group has expired; and
deleting the first expiration indicator and the first group identifier in response to a determination that membership in the first group has expired.

3. The method of claim 1, wherein updating the membership data comprises:
receiving the group membership file at the client;
comparing the member identifier to the client identification; and
storing the second group identifier and the second expiration indicator at the client in response to the member identifier matching the client identification.

4. The method of claim 1, wherein the group membership file includes the first group identifier and two or more member identifiers associated with the first group identifier, and wherein updating the membership data comprises:
comparing each of said member identifiers to the client identification; and
deleting the first group identifier and the first expiration indicator in response to the client identification matching one of said member identifiers.

5. The method of claim 1, wherein the expiration indicator comprises a date.

6. The method of claim 1, wherein the expiration indicator comprises a time.

7. The method of claim 1, further comprising:
transmitting a message including a payload and a transmitted group identifier;
receiving the message at the client; and
extracting the payload from the message in response to the first group identifier matching the transmitted group identifier.

8. An article comprising:
a machine-readable medium which stores machine-executable instructions, the instructions causing a machine having a client identification to:
store membership data, said membership data including a first group identifier corresponding to a first group and a first expiration indicator;
receive a group membership file from a host, said group membership file including a second group identifier associated with a member identifier and a second expiration indicator; and
update the membership data.

9. The article of claim 8, wherein the instructions causing the machine to update the membership data include instructions causing the machine to:
examine the first expiration indicator to determine if membership in the first group has expired; and
delete the first expiration indicator and the first group identifier in response to a determination that membership in the first group has expired.

10. The article of claim 8, wherein the instructions causing the machine to update the membership data include instructions causing the machine to:
compare the member identifier to the client identification; and
store the second group identifier and the second expiration indicator at the client in response to the member identifier matching the client identification.

11. The article of claim 8, wherein the group membership file includes the first group identifier and two or more member identifiers associated with the first group identifier,
and wherein the instructions causing the machine to update the membership data include instructions causing the machine to:
compare each of said member identifiers to the client identification; and
delete the first group identifier and the first expiration indicator in response to the client identification not matching one of said member identifiers.

12. The article of claim 8, wherein the expiration indicator comprises a date.

13. The article of claim 8, wherein the expiration indicator comprises a time.

14. The article of claim 8, further comprising instructions causing the machine to:
receive a message including a payload and a transmitted group identifier; and
extract the payload from the message in response to the first group identifier matching the transmitted group identifier.

15. An apparatus comprising:
a receiver to receive messages and a group membership file including a plurality of membership records, a membership record including a member identifier associated with a first group identifier and a first expiration indicator;
a memory to store an apparatus identification;
a membership file to store a second group identifier and an associated second expiration indicator;
a clock to output a current time; and
receiver controller coupled to the receiver, the memory, the membership file, and the clock, said receiver controller operative to update the membership file in response to one of the group membership file and the current time.

16. The apparatus of claim 15, wherein the receiver is operative to compare the client identification to the member identifier in the membership record and to store the first group identifier and the first expiration identifier in the membership file in response to the member identifier matching the apparatus identification.

17. The apparatus of claim 15, wherein the receiver controller is operative to compare the second expiration indicator to the current time and to delete the second group identifier and the second expiration indicator in response to the second expiration indicator exceeding or matching the current time.

18. The apparatus of claim 15, wherein a message includes a transmitted group identifier and a payload, and wherein the receiver controller is operative to extract the payload in response to the transmitted group identifier matching the second group identifier.

19. A system host comprising:
a memory to store a group membership file including data indicative of group memberships;
a group generator to generate membership records in a group membership file, a membership record including a group identifier, a member identifier, and an expiration indicator; and
a group controller to update the group membership file.

20. The system host of claim 19, further comprising a clock to output a current time, and wherein the group controller is operative to compare the expiration indicator to the current time and to delete the membership record in response to the expiration indicator exceeding or matching the current time.

21. The system host of claim 19, wherein the expiration indicator comprises a date.

22. The system host of claim 19, wherein the expiration indicator comprises a time.

23. A system comprising:
a system host comprising:
a group generator to generate membership records in a group membership file, a membership record including a first group identifier, a membership identifier, and a first expiration indicator; and
a transmitter to transmit the group membership file; and
a client comprising:
a receiver to receive messages and the group membership file;
a memory to store an apparatus identification;
a membership file to store a second group identifier and an associated second expiration indicator;
a clock to output a current time; and
a receiver controller coupled to the receiver, the memory, the membership file, and the clock, said receiver controller operative to update the membership file in response to one of the group membership file and the current time.

24. The system of claim 23, wherein the second expiration indicator comprises a time.

25. The system of claim 24, wherein the receiver controller is operative to compare the second expiration indicator to the current time and to delete the second group identifier and the second expiration indicator in response to the second expiration indicator exceeding or matching the current time.
